(19) United States
(12) Patent Application Publication
(10) Pub. No.: US 2013/0094087 A1
(43) Pub. Date: Apr. 18, 2013

(54) TUNABLE FILTER USING A WAVE PLATE

(71) Applicant: OPTOPLEX Corporation, Fremont, CA (US)

(72) Inventors: Daryuan Song, IRVINE, CA (US); YUNG-CHIEH HSIEH, San Jose, CA (US)

(73) Assignee: OPTOPLEX Corporation, Fremont, CA (US)

(21) Appl. No.: 13/633,005

(22) Filed: Oct. 1, 2012

Related U.S. Application Data
(60) Provisional application No. 61/540,867, filed on Sep. 29, 2011.

(51) Int. Cl. G02B 5/28

(52) U.S. Cl. CPC G02B 5/28
USPC 359/578

(57) ABSTRACT

Tunable filters are provided that have transmittances that are independent of the polarization state of an incident beam. The tunable filters include an interference bandpass filter positioned to transmit an input beam of light to produce transmitted light. A wave plate is positioned to rotate the polarization of the transmitted light and a reflector is positioned to reflect the rotated light so that it propagates through the wave plate a second time and then passes through the interference filter a second time to produce second transmitted light.

### CROSS-REFERENCE TO RELATED APPLICATIONS

This application claims the benefit of U.S. Provisional Patent Application No. 61/540,867 titled “Tunable Filter Using a Wave Plate,” filed Sep. 29, 2011, incorporated herein by reference.

### BACKGROUND OF THE INVENTION

1. Field of the Invention

The present invention relates to tunable interference filters, and more specifically, it relates to tunable filters that have a transmittance that is independent of the polarization state of the incident beam.

2. Description of Related Art

The transmission profile of an interference bandpass filter comprises the transmission peak wavelength, the transmittance and the pass bandwidth. The transmission peak wavelength is a function of the angle of incidence of incoming light. Increasing the incident angle will shift the transmission peak wavelength to a shorter wavelength. Typically, the amount of shift depends on the polarization state of the incident light. Any polarization state can be expressed in terms of two orthogonal linearly polarized states. conventionally, the designations of S-polarization and P-polarization are used to represent the two orthogonal polarizations with P-polarization being parallel to the plane of incidence. In this disclosure, the plane of incidence is referred to as the XZ plane. FIG. 1A shows a side view of a tunable filter tilted in an angle about the Y-axis. Referring to that figure, consider a circularly polarized beam 10 that propagates onto and through interference filter 12. The circularly polarized beam is characterized by the two orthogonal polarization states, i.e., P-polarization and S-polarization. The P-polarized component 14 is shown to be in the XZ plane, which is the plane of the page. The S-polarized component 16 is shown to be parallel to the Y axis, which is the Z axis and is perpendicular to the plane of the page.

When the interference filter is tilted at a large angle with respect to an incident beam, the components of the P-polarization and the S-polarization can each have a relatively different transmission profile, an example of which is shown in FIG. 1B. That is, a uniform beam, having a P component and an S component, and having an intensity that is substantially uniform over a wide bandwidth (or at least as large as the bandwidth of the interference filter), will transmit the P and S components according to the transmission profile of the particular filter. In a case where the beam makes two passes through the filter, the P-polarized component has a net transmittance of Tp×Tp, where the transmittance is a measure of the percentage transmitted. In such a case, where the S-polarized component makes two passes through the filter, the net transmittance is Ts×Ts. FIG. 1B shows the transmission profile, given in dB, of a single pass through an interference filter such as the interference filter 12 of FIG. 1A. The measure in dB can be readily converted to percentage.

The input and output beams, I(in) and I(out), of any polarization state can be expressed as follows.

I(in)=Ip(in)+Is(in), and

I(out)=Ip(out)+Is(out),

Therefore, when transmittance is characterized as a percentage and the system includes a mirror so that the beam makes two passes through the filter,

Tnet=I(out)/I(in)=(Ip(in)×Tp×Tp+Is(in)×Ts×Ts)/(Ip(in)+Is(in)).

3

In the prior art, polarization splitting elements have been used to split the incident beam into two beams according to their polarizations, P or S. An appropriate wave plate inserted into the path of one of the two beams can convert its polarization to the same as the polarization of the other beam, for instance, from S-polarization to P-polarization. As a result, both beams can have the same polarization. In this manner, the influence of different polarizations can be eliminated. Unfortunately, prior art configurations for these systems are complicated. It is desirable to provide embodiments of tunable filters that have a transmittance that is independent of the polarization state of the incident beam. It is also desirable to provide embodiments that are simplified compared to the prior art, have low polarization dependent losses, eliminate polarization splitting/recombining elements, are compact due to the elimination of the polarization splitting/recombining elements and allow the use of a dual-fiber collimator as input/output ports.

### SUMMARY OF THE INVENTION

It is an object of the present invention to provide tunable filters that have transmittances that are independent of the polarization state of an incident beam.

It is another object of the present invention to provide tunable filters that have low polarization dependent losses.

Another object of the present invention is to provide tunable filters that eliminate polarization splitting and recombining elements.

An object of the present invention is to provide tunable filters that are compact.

Another object of the present invention is to provide tunable filters that allow the use of dual-fiber collimators as input/output ports.

These and other objects of the present invention will be apparent to those skilled in the art based on the teachings of this disclosure.

A tunable filter includes an interference bandpass filter positioned to transmit an input beam of light to produce transmitted light. A wave plate is positioned to rotate the polarization of the transmitted light and a reflector is positioned to reflect the rotated light so that it propagates through the wave plate a second time and then passes through the interference filter a second time to produce second transmitted light. A mount can be provided to rotate the filter about an axis that is perpendicular to the normal of the surface of the filter. In some embodiments, one or more fiber collimators provide an input port and an output port. In an ideal case, the interference filter is selected to have about the same amount of wavelength shift for each polarization of the beam of light when the filter is tilted in various angles. Example reflectors include a mirror and a retro-reflector. Example wave plate include a ¼ waveplate and a ½ waveplate. In some cases, the input light is provided from one fiber collimator and the output light is collected by a second fiber collimator. The retro-reflector can have about the same amount of phase change on reflection for each polarization. Embodiments of the invention include methods for operating the tunable filters as well as methods for fabrication of the tunable filters. The configurations of the tunable filters provide transmittances that are independent of the polarization state of an incident beam.

### BRIEF DESCRIPTION OF THE DRAWINGS

The accompanying drawings, which are incorporated into and form a part of the disclosure, illustrate embodiments of the invention and, together with the description, serve to explain the principles of the invention.

FIG. 1A shows P- and S-polarization for a filter tilted about Y-axis.

FIG. 1B shows the transmittance of S polarization and P polarization in a single pass through an interference filter.

FIG. 2 shows the rotation of a P polarized beam by 90 degrees upon passing through a ½ wave plate, thereby changing the P-polarized beam to S-polarization relative to the interference filter.

FIG. 3 shows the rotation of a P polarized beam by 90 degrees after the beam passes twice through a ¼ wave plate.

FIG. 4A shows the transmittance of a P polarized beam and an S polarized beam in a single pass through an interference filter that has peak wavelengths for the P and S polarizations that are at about the same wavelength.

FIG. 4B shows the transmittance of a P polarized beam and an S polarized beam in a single pass through an interference filter that has peak wavelengths for the P and S polarizations at wavelengths that are about 200 nm apart.

FIG. 5 shows a side of an embodiment that can utilize a single-fiber collimator and a circulator.

FIG. 6 shows a top view of an embodiment that utilizes a dual-fiber collimator.

FIG. 7 shows a top view of an embodiment that uses two fiber collimators and a retro-reflector.

FIG. 8 shows a top view of an embodiment that uses two fiber collimators and a single ½ waveplate in one arm and further uses a retro-reflector.

FIG. 9 shows a top view of an embodiment that uses two fiber collimators, a ¼ waveplate and a mirror.

### DETAILED DESCRIPTION OF THE INVENTION

When a linearly polarized beam passes through a wave plate whose polarization axis is at an angle α with respect to the direction of polarization of the beam, the polarization direction of the beam is rotated by an angle 2α. For example, when α=45 degrees, a linearly polarized beam with its polarization direction in the vertical direction (X-axis) becomes a linearly polarized beam with its polarization direction in the horizontal direction (Y-axis). Referring specifically to FIG. 2, an input beam 20 that is P-polarized, as shown at reference number 22 passes through interference filter 24 and remains P polarized. After passing through ½ wave plate 26, beam 20 is rotated 90 degrees and then has the S-polarization orientation, as shown at reference number 28, relative to the interference filter.

FIG. 3 shows an embodiment of the invention in which a quarter wave plate is inserted between a tilted interference filter and a mirror. The quarter wave plate is oriented such that its polarization axis is 45 degrees with respect to the direction of P-polarization (X-axis). The beam passes through the ¼ wave plate and is reflected by a mirror so that the beam propagates through the ¼ wave plate a second time. The combination of the ¼ wave plate and the mirror functions as a half wave plate. The polarization of the reflected beam is changed from P-polarization to S-polarization after the beam goes through the ¼ wave plate twice. Referring specifically to FIG. 3, input beam 30 has a P-polarized component as indicated by reference number 32. After passing through the interference filter 34, the beam retains its P polarization. This beam then passes through ¼ wave plate 36 which rotates the polarization 45 degrees. This beam is then reflected from mirror 38 and passes through wave plate 36 a second time to have its polarization rotated another 45 degrees such that it has a polarization component 40 that is S-polarized relative to the interference filter.

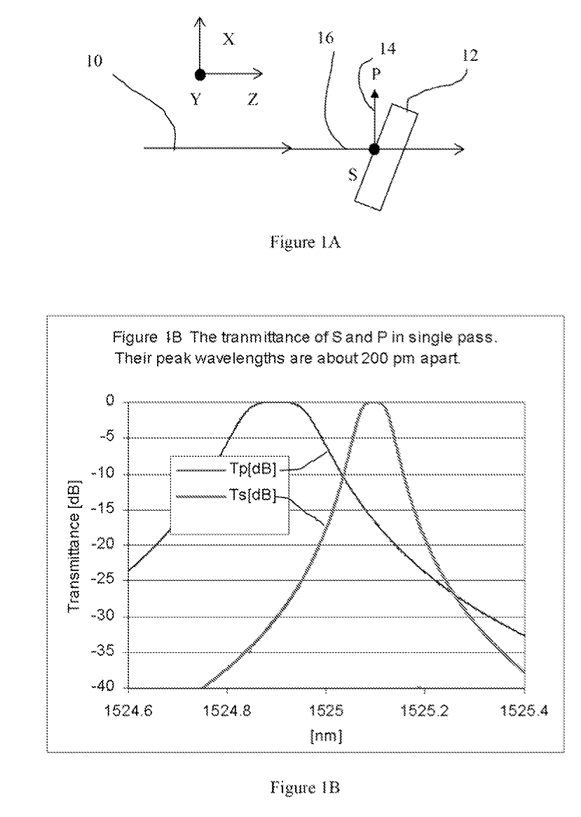

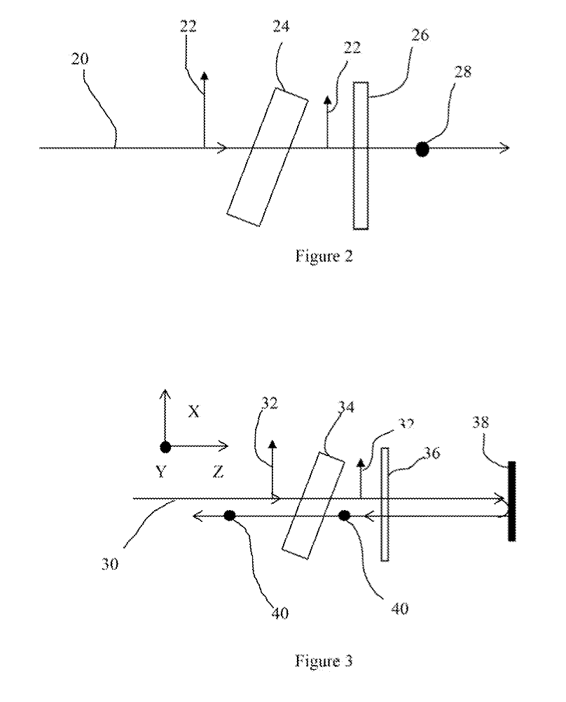

Given a uniform input beam having a bandwidth greater than the bandpass of a particular filter of interest, and referring, as an example, to the transmittance of the filter of FIG. 1B, the P-polarized component of the input beam will be transmitted through the interference filter upon a first pass, according to the Tp curve. When this beam has its polarization rotated 45 degrees and is reflected to have its polarization rotated another 45 degrees, this beam will propagate through the bandpass filter as S-polarized light. Thus, the bandpass filter will only transmit the wavelengths according to the Ts curve. Therefore, the light transmitted from the component that started as P-polarized light, will have a transmission curve that is the product of the Ts and Tp curves. Note that the net transmittance of two filters is the product of two transmittance curves in a linear scale, or the sum of two transmittance curves in a log scale.

When the portion of the input beam that is S-polarized relative to the interference filter propagates through the filter on a first pass, it will have the transmittance according to the Ts curve. After this polarization follows the same path as the P-polarized beam, it become P-polarized and the second transmission through the interference filter will again be the product of the Ts and Tp curves. Accordingly, it will make no difference what the angle of the interference filter is relative to the input beam, both polarization components will have identical transmission curves and hence, the tunable filter has a transmittance that is independent of the polarization state of the incident beam.

Thus, for the P-polarization component of an input beam, the resulting transmission profile is determined by the product of Tp and Ts.

Tnet=Ip(out)/Ip(in)=Ip(in)×Tp×Ts/Ip(in)=Tp×Ts.

Similarly, for the S-polarization component of the input beam, the resulting transmission profile is determined by the product of Tp and Ts.

Tnet=Is(out)/Is(in)=Is(in)×Ts×Tp/Is(in)=Ts×Tp.

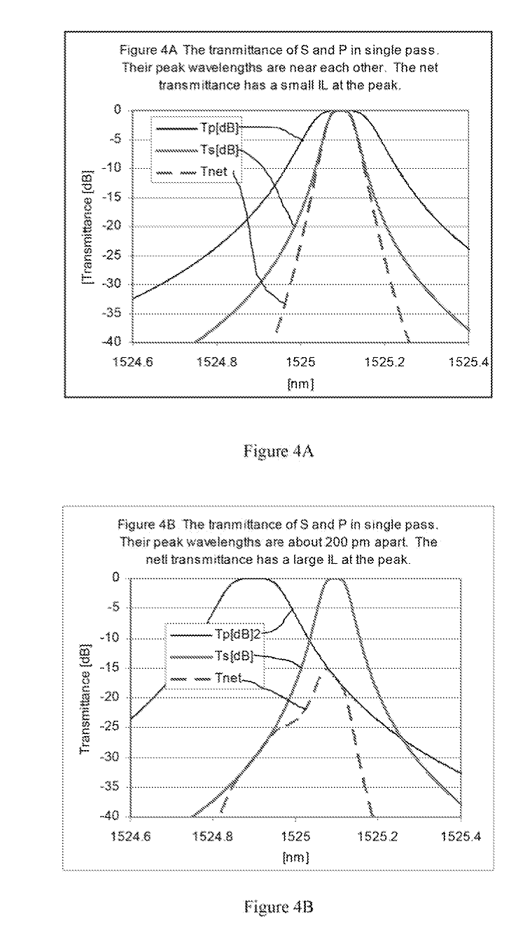

When the wavelength shift for each polarization is about the same, the product of Tp and Ts has a single peak with a small insertion loss, as shown in FIG. 4A. FIG. 4A shows the transmittance of a P-polarization (Tp) and S-polarization (Ts) in a single pass. When a mirror and wave plate are used, as described above, the net transmittance of the reflected beam becomes either Ts×Tp or Tp×Ts, as shown in the dashed line (Tnet).

It should be noted that if the transmitted peaks of P- and S-polarization in a single pass are far apart such as in FIG. 1B, then even after utilizing the current invention the net transmittance is still largely distorted, as shown in the dashed line (Tnet) in FIG. 4B. In order to achieve a small insertion loss and a symmetric profile, it is important that the filter must have about the same amount of wavelength shift for each polarization when the filter is tilted in various angles, as shown in FIG. 4A.

Thus, any polarization state can be expressed in terms of two orthogonal linearly polarized states. The input and output beams, I(in) and I(out), of any polarization state can be expressed as follows.

I(in)=Ip(in)+Is(in), and

I(out)=Ip(out)+Is(out).

Therefore,

Tnet=I(out)/I(in)=(Ip(in)×Tp ×Ts+Is(in)×Ts×Tp)/(Ip(in)+Is(in))=Ts×Tp.

The net transmittance is independent of the polarization of the input beam. In theory, the polarization dependent loss (PDL) should be zero. The residual PDL could be due to the orientation of the wave plate, and the dispersion of the wave plate. In contrast, without using the ¼ wave plate, the transmittance of a filter in an angle will have strong polarization dependence, as follows.

Tnet=(Ip(in)×Tp×Tp=Is(in)×Ts×Ts)/(Ip(in)+Is(in)).

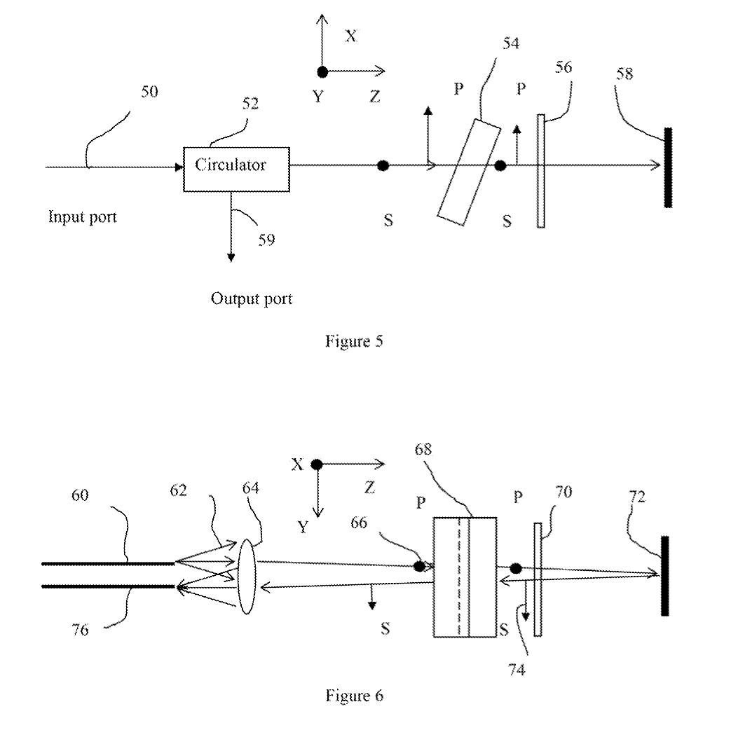

FIG. 5 illustrates an embodiment that utilizes a circulator. An input beam 50 having a P polarization is directed into a circulator 52. The output beam from circulator 52 propagates onto and through interference bandpass filter 54. The polarization of beam 50 is rotated 45 degrees by waveplate 56 and is then reflected by mirror 58 so that it propagates again through ¼ waveplate 56. Accordingly, beam 50 is S-polarized on its second pass through filter 54. Beam 50 propagates to circulator 52 and exits the system at output port 59.

FIG. 6 is top view of an embodiment that uses a dual-fiber collimator. An input fiber 60 provides an input beam 62, which is collimated by lens 64. The figure depicts the P-polarization 66 as being perpendicular to the plane of the page. The beam propagates through the tilted interference filter 68 and then through the ¼ wave plate 70, which rotates the polarization 45 degrees. Mirror 72 directs the beam back through the wave plate, which further rotates the polarization such that the beam propagating through the interference filter 68 is S polarized (74) as it passes through the filter after which it focused by lens 64 into output fiber 76.

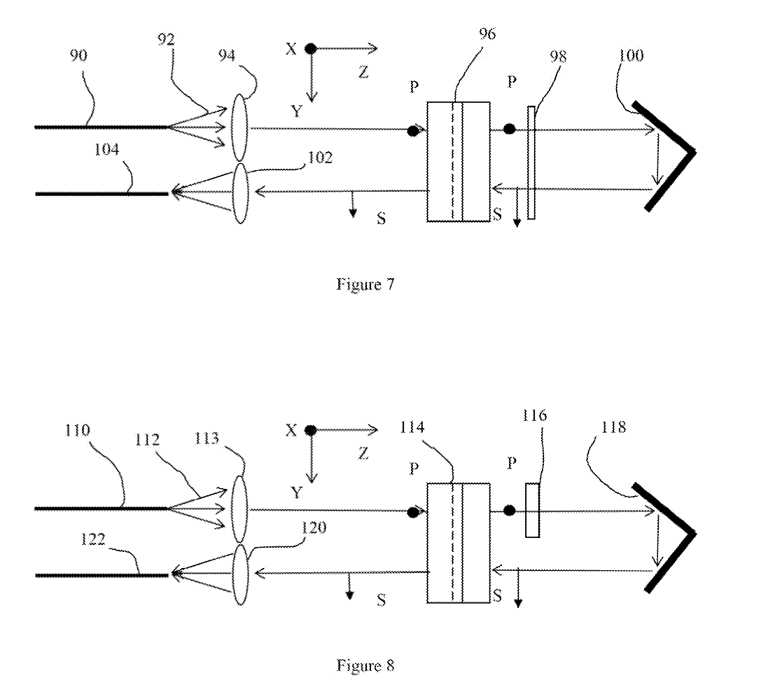

FIG. 7 is a top view of an embodiment that uses a retro-reflector (e.g., a roof-prism). Input fiber 90 provides a diverging input beam 92 which is collimated by lens 94 and directed through filter 96. This figure illustrates the case where the input beam is P-polarized. The polarization is rotated 45 degrees when is passes through waveplate 98. The beam is reflected by retro-reflector 100 so that it propagates through the wave plate a second time so that the polarization is further rotated another 45 degrees. Hence, the beam that propagates through the interference filter a second time has S polarization relative to the filter. The beam is then collected by lens 102 and focused into output fiber 104.

FIG. 8 shows a top view of an embodiment that uses a waveplate in a single arm of the device. An input fiber 110 provides a diverging input beam 112 which is collimated by optics 113 and directed through interference filter 114, ½ waveplate 116 and is reflected from retro-reflector 118 so that it passes through filter 114 a second time after which it is focused by lens 120 into output fiber 122. The P polarization component of input beam 112 is rotated 90 degrees by the waveplate so that the P-polarized component is rotated to be S-polarized relative to the filter on the second pass of the beam through the filter.

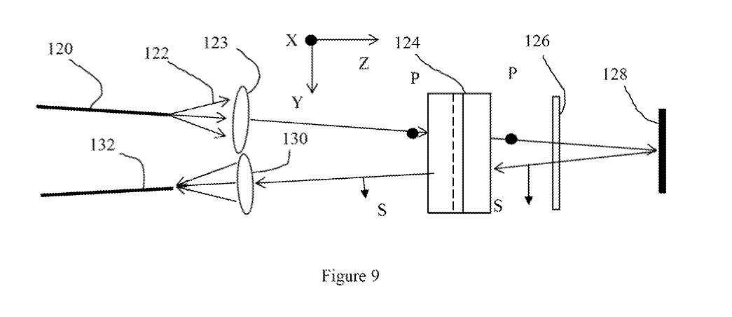

FIG. 9 shows a top view of an embodiment that uses two fiber collimators and a mirror. Input fiber 120 provides an input beam 122 which is collimated by an optic or optics 123 (e.g., a lens) so that the beam passes through interference filter 124, ¼ waveplate 126 and is reflected by mirror 128 back through the waveplate and the filter and is then directed by one or more optics 130 into output fiber 132. The P polarization component of input beam 122 is rotated 45 degrees by the waveplate on the first pass and then another 45 degrees on the second pass so that the P-polarized component is rotated to be S-polarized relative to the filter on the second pass of the beam through the filter.

The foregoing description of the invention has been presented for purposes of illustration and description and is not intended to be exhaustive, or to limit the invention to the precise form disclosed. Many modifications and variations are possible in light of the above teaching. The embodiments disclosed were meant only to explain the principles of the invention and its practical application to thereby enable others skilled in the art to best use the invention in various embodiments and with various modifications suited to the particular use contemplated. The scope of the invention is to be defined by the following claims.

We claim:

1. An apparatus, comprising:
an interference bandpass filter positioned to transmit an input beam of light to produce transmitted light;
a first wave plate positioned to rotate the polarization of said transmitted light to produce first rotated light; and
a reflector positioned to reflect said first rotated light so that it propagates through said wave plate a second time to produce second rotated light, wherein and second rotated light passes through said interference filter a second time to produce second transmitted light.

2. The apparatus of claim 1, further comprising means for rotating said filter about an axis that is perpendicular to the normal of the surface of said filter.

3. The apparatus of claim 1, further comprising a fiber collimator having an input port and an output port, wherein said input port is configured to direct said input beam of light toward said interference filter, wherein said output port is configured for receiving, said second transmitted light.

4. The apparatus of claim 1, wherein said interference filter is selected to have about the same amount of wavelength shift for each polarization of said beam of light when said filter is tilted in various angles.

5. The apparatus of claim 1 wherein said reflector is a mirror.

6. The apparatus of claim 1, wherein said first wave plate is a ¼ waveplate and said reflector is a mirror.

7. The apparatus of claim 3, wherein said fiber collimator comprises a dual fiber collimator, wherein said input port and said output port are on said dual-fiber collimator and wherein said reflector is a mirror.

8. The apparatus of claim 7, wherein both fibers of said, dual-fiber collimator are oriented on the YZ plane such that said input beam and the reflected beam have the same angle of incidence.

9. The apparatus of claim 1, wherein said reflector comprises a retro-reflector.

10. The apparatus of claim 9, wherein said retro-reflector comprises a roof prism.

11. The apparatus of claim 8, wherein said retro-reflector is selected to have about the same amount of phase change on reflection for each polarization.

12. The apparatus of claim 1, wherein said reflector comprises a retro-reflector and wherein said wave plate is selected from the group consisting of a ¼ wave plate, and a ½ wave plate,

13. The apparatus of claim 12, wherein said wave plate covers both sides of said retro-reflector.

14. The apparatus of claim 12, wherein said ½ wave plate covers one side of said retro-reflector.

15. The apparatus of claim 1, further comprising means for providing said input beam and means for collecting said second transmitted light.

16. The apparatus of claim 15, wherein said means for providing said input beam comprises a first fiber collimator and wherein said means for collecting said second transmitted light comprises a second fiber collimator.

17. The apparatus of claim 16, wherein said first waveplate comprises a ½ waveplate, wherein said reflector comprises a retro-reflector.

18. A method, comprising:
transmitting an input beam of light through an interference bandpass filter to produce transmitted light;
rotating with a first wave plate, the polarization of said transmitted light to produce first rotated light; and
reflecting, with a reflector, said first rotated light so that it propagates through said wave plate a second time to produce second rotated light, wherein and second rotated light passes through said interference filter a second time to produce second transmitted light.

19. The method of claim 18, further comprising rotating, with means for rotating, said filter about an axis that is perpendicular to the normal of the surface of said filter.

20. The method of claim 18, further comprising providing a fiber collimator having an input port and an output port, wherein said input port is configured to direct said input beam of light toward said interference filter, wherein said output port is configured for receiving said second transmitted light, the method further comprising directing, from said input port, said input beam of light toward said interference filter and receiving, in said output port, said second transmitted light.

21. The method of claim 18, wherein said interference filter is selected to have about the same amount of wavelength shift for each polarization of said beam of light when said filter is tilted in various angles.

22. The method of claim 18, wherein said reflector is a mirror.

23. The method of claim 18, wherein said first wave plate is a ¼ waveplate and said reflector is a mirror.

24. The method of claim 20, wherein said fiber collimator comprises a dual fiber collimator, wherein said input port and said output port are on said dual-fiber collimator and wherein said reflector is a mirror.

25. The method of claim 24, wherein both fibers of said dual-fiber collimator are oriented on the YZ plane such that said input beam and the reflected beam have the same angle of incidence.

26. The method of claim 18, wherein said reflector comprises a retro-reflector.

27. The method of claim 26, wherein said retro-reflector comprises a roof prism.

28. The method of claim 25, wherein said retro-reflector is selected to have about the same amount of phase change on reflection for each polarization.

29. The method of claim 18, wherein said reflector comprises a retro-reflector and wherein said wave plate is selected, from the group consisting of a ¼ wave plate, and a ½ wave plate.

30. The method of claim 29, wherein said wave plate covers both sides of said retro-reflector.

31. The method of claim 29, wherein said ½ wave plate covers one side of said retro-reflector.

32. The method of claim 18, further providing said input beam from a first fiber collimator and collecting said second transmitted light with a second fiber collimator.

33. The method of claim 32, wherein said first waveplate comprises a ½ waveplate, wherein said reflector comprises a retro-reflector.

34. An apparatus, comprising:
an interference bandpass filter;
a reflector; and
means for polarization rotation, wherein said means for polarization rotation is positioned between said interference bandpass filter and said reflector, wherein the polarization orientation of a beam that propagates through said interference filter will be rotated 90 degrees by said means for polarization rotation to produce a polarization rotated beam and wherein said reflector will cause said polarization rotated beam to propagate through said interference bandpass filter a second time.
